(19) United States
(12) Patent Application Publication
(10) Pub. No.: US 2023/0351074 A1
(43) Pub. Date: Nov. 2, 2023

(54) TOPOLOGY AND MATERIAL COLLABORATIVE ROBUST OPTIMIZATION DESIGN METHOD FOR COMPOSITE MATERIAL SUPPORT STRUCTURE

(71) Applicant: ZHEJIANG UNIVERSITY, Hangzhou (CN)

(72) Inventors: Jin CHENG, Hangzhou (CN); Deshang Peng, Hangzhou (CN); Zhenyu LIU, Hangzhou (CN); Jianrong TAN, Hangzhou (CN)

(21) Appl. No.: 18/338,336

(22) Filed: Jun. 20, 2023

Related U.S. Application Data
(63) Continuation of application No. PCT/CN2021/079564, filed on Mar. 8, 2021.

(51) Int. Cl. G06F 30/23; G06F 111/04

(52) U.S. Cl. CPC G06F 30/23; G06F 2111/04

(57) ABSTRACT

A topology and material collaborative robust optimization design method for a composite material support structure. The method comprises: considering the uncertainties in the manufacture and service of the composite support structure, describing the amplitude and direction of an external load with insufficient samples and a matrix material property with sufficient samples as interval variables and a bounded probabilistic variable, respectively; discretizing the design domain and the volume distribution of the particle reinforcement as two sets of design variables, setting physical and geometric constraints, and establishing a topology and material collaborative robust optimization model; solving by the moving asymptote algorithm: decoupling the probabilistic and interval uncertainties, and determining the worst working condition; estimating the mean and standard deviation of the objective performance under the worst working condition, so as to construct an objective function; calculating the gradient of objective and constraint functions with respect to the design variables for iteration.

### CROSS-REFERENCE TO RELATED APPLICATIONS

The present application is a continuation of International Application No. PCT/CN2021/079564, filed on Mar. 8, 2021, the contents of which is incorporated herein by reference in its entirety.

### TECHNICAL FIELD

The present disclosure belongs to the field of the optimization design of equipment structure, and relates to a topology and material collaborative robust optimization design method for a composite material support structure.

### BACKGROUND

Topology optimization, as a method to allocate the distribution of limited materials in the design domain so as to optimize the objective performance of a structure, has been widely applied in product design, and has further progressed with the promotion of the additive manufacturing technology in recent years. Collaborative optimization considering the topology and material distribution of reinforced materials has also received extensive attention. Since there are various uncertainties in the process of manufacture and use, the influence of uncertainties must be considered in the design stage in order that the theoretical results of topology optimization will not deteriorate after actual manufacturing.

Due to the huge calculation amount and complicated theoretical analysis, uncertainties are often ignored in the existing collaborative optimization of structural topology and material distribution. However, due to the uncertainties in composite material preparation and product manufacturing, the optimization design that ignores the uncertainties may lead to the failure of design results.

Generalized composite materials (using a microscopic variable lattice structure to realize the gradient properties of the same material with different equivalent physical properties) have been widely investigated in recent years. However, due to the limitation of current additive manufacturing technology, the actual product performance often deteriorates. The reasons are as follows: 1) it is difficult to completely reproduce a tiny topological structure in the lattice; 2) manufacturing errors are unavoidable in the process of additive manufacturing, which inevitably introduce geometric boundary uncertainty at the microscopic level of the lattice structure. Whereas, the collaborative robust optimization of the distributions of multiple materials in a structure need to consider the uncertainty of the interfaces among different materials, which is still difficult in theoretical analysis.

Therefore, particle reinforced composites (such as the presently widely used carbon fiber reinforced plastics, particle reinforced metals or cermet materials, etc.) will be the main form of composite materials suitable for practical application for a long time to come.

### SUMMARY

In order to solve the problem of collaborative robust optimization design for topology and material distribution of a particle reinforced composite material support structure under the influence of multi-source uncertainties, the present disclosure provides a topology and material collaborative robust optimization design method for a composite material support structure, which includes the following steps: considering the uncertainties in the manufacture and service of a support structure made of a particle reinforced composite material, regarding the amplitude and direction of an external load with insufficient samples as interval uncertainties, and regarding the material properties of matrix material and particle reinforcement with sufficient samples as bounded probabilistic uncertainties; discretizing the design domain and the volume distribution of the particle reinforcement and generating two sets of design variables, setting physical and geometric constraints, and establishing a topology and material collaborative robust optimization model; solving by a moving asymptote algorithm: firstly, decoupling the hybrid probabilistic and interval uncertainties, and determining a worst working condition based on the gradient of objective structural performance; estimating the mean and standard deviation of the objective structural performance to be optimized under the worst working condition by means of a univariate dimension-reduction method and Laguerre integration, based on which an objective function is constructed; finally, calculating the gradient of objective and constraint functions with respect to the two sets of design variables for iteration. The method efficiently solves the problem of collaborative robust optimization design for the topology and material distribution of the particle reinforced composite material support structure under both probabilistic and interval uncertain factors, and is very valuable to engineering application.

The present disclosure is realized by the following technical solution: a topology and material collaborative robust optimization design method for a composite material support structure, the method including the following steps:

1) Considering the following uncertainties in the manufacture and service process of a particle reinforced composite support structure: material properties of a matrix material and a particle reinforcement of the support structure, the amplitude and direction of an external load on the support structure.

The amplitude and direction of the external load short of sufficient sample information are regarded as interval uncertainties; the material properties of the matrix material and particle reinforcement with sufficient sample information are regarded as bounded probabilistic uncertainties, and every bounded probabilistic uncertainty is described as a random variable subject to generalized beta distribution.

2) Discretizing the design domain of the support structure, which is specifically as follows:

Simplifying the force condition of the support structure into a two-dimensional plane stress state, retaining installation holes and removing structural details to improve computing efficiency; placing the simplified support structure in a regular rectangular design domain, and dividing the design domain into Nₓ×N_{y} square units, where Nₓ, N_{y} are numbers of divisions along x, y axes respectively; based on a solid isotropic material with penalization (SIMP) topology optimization framework, imparting each element with a unique design variable ρₑ∈[0,1] (e=1,2, . . . , Nₓ·N_{y}).

3) Discretizing the volume distribution of the particle reinforcement in the matrix of the support structure, which is specifically as follows:

3.1) Assuming that the volume fraction of the particle reinforcement in the matrix only changes along the y axis, the volume fraction with the same y coordinate is regarded as a constant, and the volume fraction of the particle reinforcement in each layer is recorded as δₗ(l=1,2, . . . , N_{y}).

3.2) Calculating the Young's modulus E₀ₑ^{<l>} and the Poisson's ratio vₑ^{<l>} of each element in the lth layer based on the Halpin-Tsai microstructure model.

3.3) Introducing a penalty factor p to calculate the Young's modulus Eₑ^{<l>} of each unit in the lth layer under the topology optimization framework as follows:

Eₑ^{<l>}(ρₑ)=Eₘᵢₙ+ρₑ^{p}(E₀ₑ^{<l>}−Eₘᵢₙ) (e∈l^{<e>}, l=1,2, . . . , N_{y}) Eq. 1

where Eₘᵢₙ is a minimum allowable value; l^{<e>} is a set of unit serial numbers in the lth layer.

4) Imposing physical and geometric constraints on the discretized structure, specifically includes the following sub-steps:

4.1) Imposing physical constraints including fixing or supporting and the external load according to the classical finite element method.

4.2) Imposing geometric constraints including specified holes in the structure and areas where materials are forcibly retained.

The method is to set a design variable corresponding to an element in the hole as ρₑ≡0 and set a design variable corresponding to an element in the area where materials are to be retained as ρₑ≡1, and the values thereof are kept unchanged in subsequent optimization process.

5) Establishing, by taking a structural yield c of the support structure under the influence of bounded hybrid uncertainties as an objective performance to be optimized, and characterizing the objective performance by the mean and standard deviation of the structural yield under the worst working condition, a topology and material distribution collaborative robust optimization design model of a particle reinforced composite material support structure, as shown in Eq.2:

$${min}_{ρ , δ} \{ {μ}_{c ( ρ , δ , X , \tilde{I} )} , {σ}_{c ( ρ , δ , X , \tilde{I} )} \} \qquad Eq . 2$$

$$s . t . \{ \begin{matrix}\tilde{I} = arg {min}_{I} c ( ρ , δ , {μ}_{X} , I ) \\ s . t . ρ = {ρ}^{this \_ itr} , δ = {δ}^{this \_ itr}\end{matrix}$$

$${g}_{1} ( ρ ) = {V}_{1} ( ρ ) / {V}_{0} = {\sum }_{e}^{{N}_{x} {N}_{y}} {ρ}_{e} / {V}_{0} \leq \overline{V}$$

$${g}_{2} ( ρ , δ ) = {V}_{2} ( ρ , δ ) / {V}_{1} ( ρ ) = {\sum }_{l}^{{N}_{y}} {\sum }_{e ∈ {l}^{< e >}}^{{N}_{x}} {ρ}_{e} \cdot {δ}_{l} / {V}_{1} ( ρ ) \leq {\overline{V}}_{GPL}$$

$$K ( ρ , δ , X ) U = F ( I )$$

$$ρ = {( {ρ}_{1} , {ρ}_{2} , ⋯ , {ρ}_{{N}_{x} \cdot {N}_{y}} )}^{T} , 0 \leq {ρ}_{min} \leq {ρ}_{e} \leq 1 ( e = 1 , 2 , ⋯ , {N}_{x} \cdot {N}_{y} )$$

$$δ = {( {δ}_{1} , {δ}_{2} , ⋯ , {δ}_{{N}_{y}} )}^{T} , 0 \leq {δ}_{min} \leq {δ}_{l} \leq {δ}_{max} ( l = 1 , 2 , ⋯ , {N}_{y} )$$

$$X = {( {X}_{1} , {X}_{2} , ⋯ , {X}_{m} )}^{T} , I = {( {f}_{1} , {f}_{2} , ⋯ , {f}_{n} , {α}_{1} , {α}_{2} , ⋯ , {α}_{n} )}^{T}$$

where 92 =(ρ₁, ρ₂, . . . , ρ_{N}_{ₓ}_{·N}_{_{y}})^{T} and δ=(δ₁, δ₂, . . . , δ_{N}_{_{y}})^{T} are the design vectors for topology optimization and material distribution respectively, ρₘᵢₙ is a minimum allowable value of a topology optimization design variable, δₘᵢₙ and δₘₐₓ are the minimum and maximum allowable values of a material distribution design variable; the bounded probabilistic uncertainty vector X=(X₁, X₂, . . . , Xₘ)^{T} contains the m uncertain material properties of the matrix and reinforcement of the support structure; the interval uncertainty vector I=(f₁, f₂, . . . , fₙ, α₁, α₂, . . . , αₙ)^{T} contains the amplitudes f₁, f₂, . . . fₙ and direction angles α₁, α₂, . . . , αₙ of n uncertain external loads on the support structure; two sets of design vectors in the current iteration are ρ=ρ^{this_itr}, δ=δ^{this_itr}, respectively.

g₁(ρ) is a constraint function about a structural topology, where

$${V}_{1} ( ρ ) = {\sum }_{e}^{{N}_{x} {N}_{y}} {ρ}_{e}$$

is a total volume of the current support structure; Vₒ is a volume of the design domain; V̅ is a given spatial utilization ratio of the design domain; ρₑ=V̅ is initialized.

g₂(ρ, δ) is a constraint function about the usage of the reinforcement, where

$${V}_{2} ( ρ , δ ) = {\sum }_{l}^{{N}_{y}} {\sum }_{e ∈ {l}^{< e >}}^{{N}_{x}} {ρ}_{e} \cdot {δ}_{l}$$

is the usage of the particle reinforcement in the current support structure; V̅_{GPL} is a given utilization rate of the particle reinforcement; δₗ=V̅_{GPL} is initialized.

In the balance equation K(ρ,δ,X)U=F(I) of a support structure, U is a (2(Nₓ+1)(N_{y}+1)) -dimensional nodal displacement vector; K(ρ,δ,X) is a (2(Nₓ+1)(N_{y}+1))×(2(Nₓ+1)(N_{y}+1))-dimensional global stiffness matrix; F(I) is a (2(Nₓ+1)(N_{y}+1))-dimensional nodal force vector.

Ĩ is an interval uncertainty vector corresponding to the worst working condition of the support structure; c(ρ, δ, X ,Ĩ) is a yield of the support structure under the worst working condition Ĩ; and a specific way to determine the worst working condition Ĩ is as follows:

5.1) Writing the structural yield under the influences of both interval and bounded probabilistic uncertainties as Eq.3:

c(ρ, δ, X, I)=U^{T}K(ρ,δ,X)U=F(I)^{T}K⁻¹(ρ, δ, X)F(I) Eq. 3

5.2) Letting x=μₓ=(μₓ_{₁}, μₓ_{₂}, . . . , μₓ_{ₘ})^{T} in c(ρ,δ,X,I), where μₓ_{₁}, μₓ_{₂}, . . . , μₓ_{ₘ} are the averages of uncertainties X₁, X₂, . . . , Xₘ, respectively, then the structural yield is only influenced by interval uncertainties I, which is written as c(ρ, δ, μₓ,I)=c(ρ,δ,I); where global stiffness matrix K (ρ,δ,μₓ) is constant in each iteration;

5.3) Denoting the nodal force vector as the sum of the nodal force vectors of all external loads:

$$F ( I ) = {\sum }_{i}^{n} {F}_{i} ( {f}_{i} , {α}_{i} ) \qquad Eq . 4$$

And there is:

$${F}_{i} = {F}_{ix} + {F}_{iy} = ‖ {F}_{ix} ‖ \frac{{F}_{ix}}{‖ {F}_{ix} ‖} + ‖ {F}_{iy} ‖ \frac{{F}_{iy}}{‖ {F}_{iy} ‖} = {f}_{i} cos {α}_{i} {e}_{ix} + {f}_{i} sin {α}_{i} {e}_{iy} ( i = 1 , 2 , ⋯ , n ) \qquad Eq . 5$$

where eᵢₓ, e_{iy}, are the unit nodal force vectors along x, y axes respectively at the node where an external load Fᵢ is imposed;

5.4) According to the theory of linear elasticity, the overall effect of n uncertain loads is equivalent to the superposition of the individual effect of each load:

$$c ( ρ , δ , I ) = {[ {\sum }_{i}^{n} {F}_{i} ( {f}_{i} , {α}_{i} , ) ]}^{T} {K}^{- 1} [ {\sum }_{i}^{n} {F}_{i} ( {f}_{i} , {α}_{i} , ) ] = {\sum }_{i}^{n} {F}_{i}^{T} {K}^{- 1} {F}_{i} \qquad Eq . 6$$

In Eq.6, the amplitude and the direction angle of the uncertain load are derived respectively, and the worst working condition Ĩ=(\tilde{f}₁, \tilde{f}₂, . . . , \tilde{f}ₙ, \tilde{α}₁, \tilde{α}₂, . . . , \tilde{α}ₙ)^{T} is obtained by solving ∂c(ρ,δ,I)/∂fᵢ=0, ∂c(ρ, δ,I)/∂αᵢ=0.

In Eq.2 μ_{c(ρ,δ,X,Ĩ)}, σ_{c(ρ, δ, X, Ĩ)} are respectively the mean and standard deviation of the structural yield c(ρ,δ,X ,Ĩ) under the influence of bounded probabilistic uncertainty vector X and the worst working condition, which are calculated as follows:

5.5) Restoring μₓ in c(ρ,δ,μₓ,Ĩ) as X , and recording c(ρ,δ,X,Ĩ) as \tilde{c}(ρ, δ, X) for short.

5.6) Using a Rahman univariate dimension-reduction method to expand \tilde{c}(ρ,δ,X):

$$\tilde{c} ( ρ , δ , X ) \approx {\sum }_{i = 1}^{m} \tilde{c} ( ρ , δ , {X}_{< i >} ) - ( m - 1 ) \tilde{c} ( ρ , δ , {μ}_{X} ) where \qquad Eq . 7$$

$${X}_{< i >} ( 1 , 2 , ⋯ , m )$$

is defined according to Eq.8

X_{<i>}=(μ_{X}_{₁}, μ_{X}_{₂}, . . . , μ_{X}_{_{i−1}}, Xᵢ, μ_{X}_{ᵢ₊₁}, . . . μ_{X}_{ₘ})^{T} Eq. 8

5.7) According to Eq.7, transforming a high-dimensional integration of the first-order and second-order origin moments of \tilde{c}(ρ,δ,X) into several one-dimensional integration operations:

$$E ( \tilde{c} ( ρ , δ , X ) ) \approx E [ {\sum }_{i = 1}^{m} \tilde{c} ( ρ , δ , {X}_{< i >} ) - ( m - 1 ) \tilde{c} ( ρ , δ , {μ}_{X} ) ] = {\sum }_{i = 1}^{m} {\int }_{0}^{+ ∞} \tilde{c} ( ρ , δ , {X}_{< i >} ) \cdot ψ ( {X}_{i} ) {dX}_{i} - ( m - 1 ) \tilde{c} ( ρ , δ , {μ}_{X} ) \qquad Eq . 9$$

$$E ( {\tilde{c}}^{2} ( ρ , δ , X ) ) \approx E [ {( {\sum }_{i = 1}^{m} \tilde{c} ( ρ , δ , {X}_{< i >} ) - ( m - 1 ) \tilde{c} ( ρ , δ , {μ}_{X} ) )}^{2} ] = {\sum }_{i = 1}^{m} {\int }_{0}^{+ ∞} {\tilde{c}}^{2} ( ρ , δ , {X}_{< i >} ) \cdot ψ ( {X}_{i} ) {dX}_{i} + 2 {\sum }_{1 \leq p < q \leq m} [ {\int }_{0}^{+ ∞} \tilde{c} ( ρ , δ , {X}_{< p >} ) \cdot ψ ( {X}_{p} ) {dX}_{p} ] \cdot [ {\int }_{0}^{+ ∞} \tilde{c} ( ρ , δ , {X}_{< q >} ) \cdot ψ ( {X}_{q} ) {dX}_{q} ] - 2 ( m - 1 ) \tilde{c} ( ρ , δ , {μ}_{X} ) {\sum }_{i = 1}^{m} {\int }_{0}^{+ ∞} \tilde{c} ( ρ , δ , {X}_{< i >} ) \cdot ψ ( {X}_{i} ) {dX}_{i} + {( m - 1 )}^{2} {\tilde{c}}^{2} ( ρ , δ , {μ}_{X} ) \qquad Eq . 10$$

where ψ(Xᵢ) in Eq.10 is a probability distribution function of the bounded probabilistic uncertainty Xᵢ, which is determined when modelling Xi using the generalized beta distribution;

5.8) Calculating each one-dimensional integral in Eq.9 and Eq.10 using a Laguerre integration format:

$${\int }_{0}^{+ ∞} \tilde{c} ( ρ , δ , {X}_{〈 i 〉} ) \cdot ψ ( {X}_{i} ) {dX}_{i} \approx {\sum }_{j = 1}^{t} \tilde{c} ( ρ , δ , {X}_{〈 i 〉}^{( j )} ) exp ( {X}_{i}^{( j )} ) {λ}^{( j )} \qquad Eq . 11$$

where t is the number of Laguerre integration points; Xᵢ^{(j)}, λ^{(j)}, are respectively an integration point and its corresponding weight given by Laguerre integration rules; X_{<i>}^{(j)} is determined using Xᵢ^{(j)} by Eq. 8;

5.9) Obtaining the mean and standard deviation of the structural yield under the worst working condition by Eq.12:

$$\{ \begin{matrix}{μ}_{c ( ρ , δ , X , \tilde{I} )} = E ( \tilde{c} ( ρ , δ , X ) ) \\ {σ}_{c ( ρ , δ , X , \tilde{I} )} = \sqrt{E ( {\tilde{c}}^{2} ( ρ , δ , X ) ) - {E}^{2} ( \tilde{c} ( ρ , δ , X ) )}\end{matrix} \qquad Eq . 12$$

6) Solving the collaborative robust optimization design model in Eq.2 by a moving asymptote algorithm, each iteration being specifically as follows:

6.1) Introducing a weight w and defining the objective function J(ρ,δ,X,I) according to Eq.13:

J(ρ,δ,X, I)=μ_{c(ρ, δ,X,Ĩ)}+wσ_{c(ρ, δ,X,Ĩ)} Eq. 13

6.2) Calculating the gradient of the objective and constraint functions with respect to design variables ρₑ:

$$\frac{J ( ρ , δ , X , I )}{\partial {ρ}_{e}} = \frac{\partial {μ}_{c ( ρ , δ , X , \tilde{I} )}}{\partial {ρ}_{e}} + w \frac{\partial {σ}_{c ( ρ , δ , X , \tilde{I} )}}{\partial {ρ}_{e}} \qquad Eq . 14$$

$$\frac{\partial {g}_{1} ( ρ )}{\partial {ρ}_{e}} = \frac{1}{{V}_{0}} \qquad Eq . 15$$

$$\frac{\partial {g}_{2} ( ρ , δ )}{\partial {ρ}_{e}} = \frac{{δ}_{l} \cdot {V}_{1} ( ρ ) - {\sum }_{l}^{{N}_{y}} {\sum }_{e ∈ {l}^{〈 e 〉}}^{{N}_{x}} {ρ}_{e} \cdot {δ}_{l}}{{( {V}_{1} ( ρ ) )}^{2}} ( e ∈ {l}^{〈 e 〉} ) \qquad Eq . 16$$

6.3) Calculating the gradient of the objective and constraint functions with respect to design variables δᵢ:

$$\frac{J ( ρ , δ , X , I )}{\partial {δ}_{l}} = \frac{\partial {μ}_{c ( ρ , δ , X , \tilde{I} )}}{\partial {δ}_{l}} + w \frac{\partial {σ}_{c ( ρ , δ , X , \tilde{I} )}}{\partial {δ}_{l}} \qquad Eq . 17$$

$$\frac{\partial {g}_{1} ( ρ )}{\partial {δ}_{l}} = 0 \qquad Eq . 18$$

$$\frac{\partial {g}_{2} ( ρ , δ )}{\partial {δ}_{l}} = {\sum }_{e ∈ {l}^{〈 e 〉}}^{{N}_{x}} {ρ}_{e} / {V}_{1} ( ρ ) \qquad Eq . 19$$

6.4) Based on the gradient information of the objective and constraint functions, updating two sets of design vectors ρ, δ simultaneously by a moving asymptote algorithm.

6.5) Checking the difference between the objective function values in the current and previous iterations. For the first iteration, the difference is defined as the objective function value; if the difference is less than a convergence threshold, outputting updated design variables; otherwise, repeating steps 5) to 6).

The present disclosure has the following beneficial effects.

1) The following uncertainties in the manufacture and service of the support structure made of particle reinforced composite materials are taken into consideration: the material properties of the matrix material and particle reinforcement of the support structure, and the amplitude and direction of the external loads; since it is difficult to obtain sufficient sample information of the external loads, the uncertainties of the amplitude and direction are regarded as interval uncertainties; the material properties of the matrix and particle reinforcement with sufficient sample information are regarded as bounded probabilistic uncertainties, which are described as random variables subject to generalized beta distribution;

the deficiency in the existing collaborative robust optimization design methods for structural topology and material distribution that only considers probabilistic or interval uncertainties is overcome, and the constructed topology and material collaborative robust optimization model for the support structure accords well with engineering practice.

2) According to the classical finite element framework, the explicit expression of an objective performance with respect to design variables and uncertain parameters is established; with the introduction of the hypothesis of linear elastic deformation, the final deformation of the structure is obtained by superimposing the deformation caused by the independent action of each external load, and the gradient information of the objective performance with respect to the uncertain external loads is calculated accordingly, so that the worst working condition corresponding to the worst objective performance of the structure is obtained, thus the limitation of existing topology and material collaborative robust optimization methods in their inability to provide the worst working condition is overcome, and a theoretical basis for ensuring the safe service of the structure is provided.

3) Aiming at the particle reinforced composite materials widely applied in manufacturing industry, a collaborative robust optimization method for topology and material distribution of a support structure made of a particle reinforced composite material is established, which overcomes the deficiency in present practical production that reinforcement can only be added in a specific mode, extends the freedom of the practical use of reinforcement, and improves the contribution of the particle reinforcement in enhancing the structural performance of a product; moreover, the design results given by the collaborative robust optimization of structural topology and material distribution have good manufacturability.

4) By introducing a high-precision Laguerre integration, a numerical method for accurately estimating the mean and standard deviation of the objective structural performance is proposed. Compared with the existing method for estimating the statistical moments of the structural performance of a product considering hybrid probabilistic and interval uncertainties, this method is more compatible with the mature collaborative robust optimization framework for topology and material distribution, and can efficiently derive the gradient information of the objective performance with respect to design variables for iterative optimization.

### BRIEF DESCRIPTION OF DRAWINGS

FIG. 1 is a flow chart of the topology and material collaborative robust optimization design for a composite support structure.

FIG. 2 is a three-dimensional appearance diagram of a certain type of tunnel boring mechanism and a schematic diagram of the position of support structures in the inner cutterhead.

FIG. 3 is an initial design diagram of a support structure.

FIG. 4 is a schematic diagram of the design domain for the topology and material collaborative robust optimization of a support structure.

FIG. 5 is the result of the topology and material collaborative robust optimization design for a support structure.

FIG. 6 is the final design drawing of the support structure obtained by smoothing the result of the topology and material collaborative robust optimization design.

### DESCRIPTION OF EMBODIMENTS

The present disclosure will be further explained with reference to the attached drawings and specific examples.

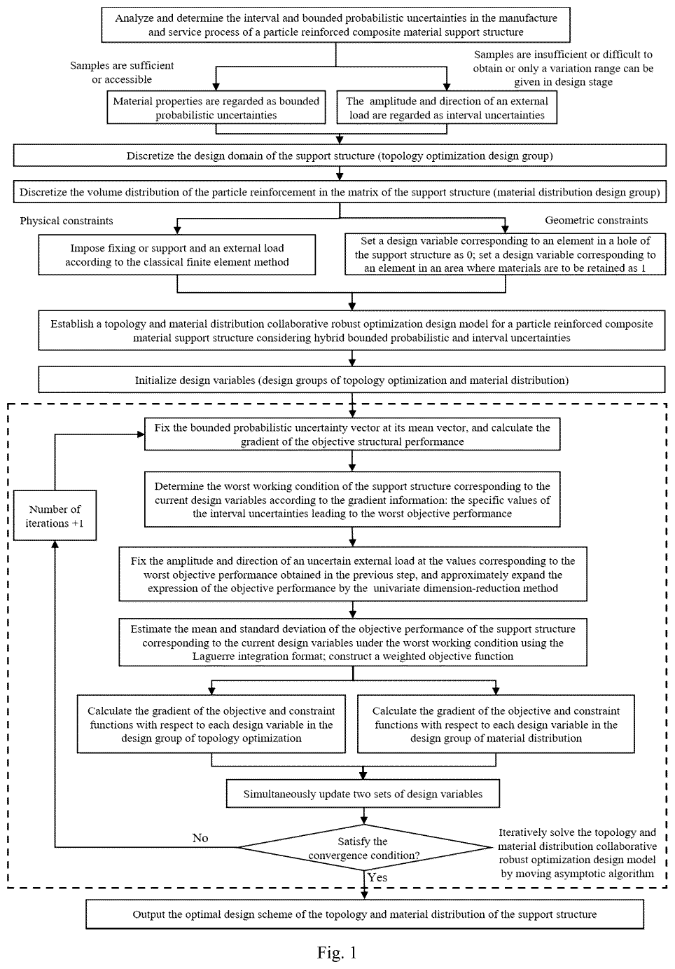

The information involved in the figures is the practical application data in the topology and material collaborative robust optimization design for a support structure in the cutterhead of a certain type of tunnel boring mechanism. FIG. 1 is the flow chart of the p topology and material collaborative robust optimization design for a composite material support structure.

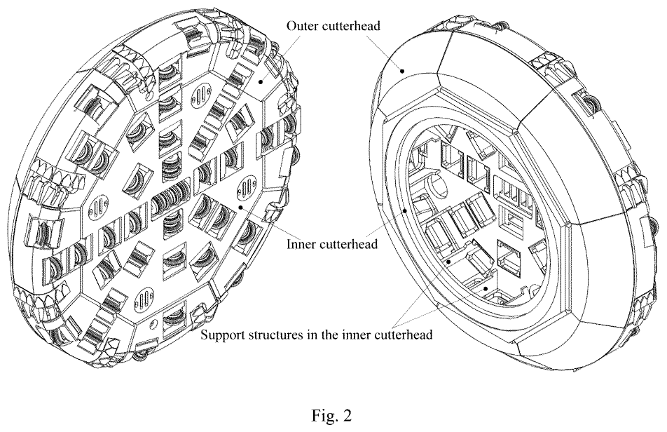

1. By taking the cutterhead support structure in a certain type of tunnel boring mechanism made of high-strength low-alloy steel reinforced with SiC particles with the maximum allowable volume fraction of 2% as shown in FIG. 2 as a research object, the uncertainties of the support structure in the manufacture and service process are considered:

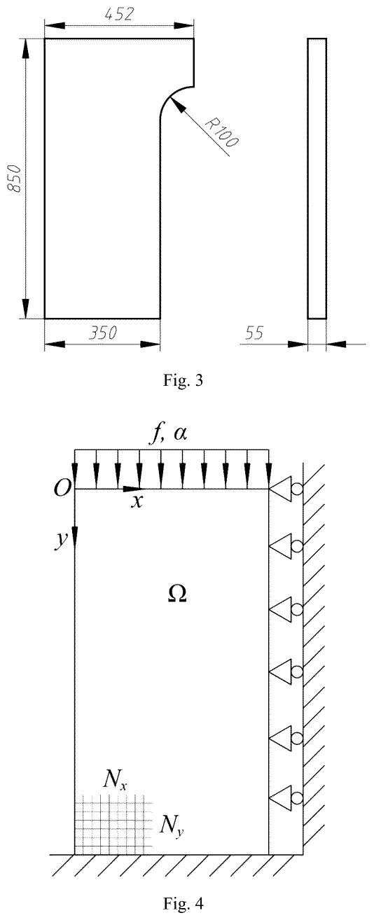

1.1) FIG. 3 shows the relevant dimensions of the initial design of the cutterhead support structure in the tunnel boring mechanism, and FIG. 4 shows the boundary setting for collaborative robust optimization. The support structure is subject to an axial load at its top during the cutting movement of the tunnel boring mechanism; the load is considered as a uniformly distributed linear load, and its amplitude and direction are uncertain due to the fluctuation of the physical properties of the rock strata being cut. However, since it is difficult to measure the external load during the cutting operation of the tunnel boring mechanism, it is difficult to obtain sufficient sample information of the external load, so its amplitude f and direction angle α are regarded as interval uncertainties.

1.2) Among the material properties of the materials used for the support structure of the inner cutterhead, the Young's modulus E_{M} and Poisson's ratio v_{M} of the matrix's high-strength low-alloy steel are obviously uncertain due to the uneven physical properties of the raw material and the fluctuation of metallurgical process, but sufficient sample information can be obtained by measuring the finished product, so they are regarded as bounded probabilistic uncertainties; SiC reinforced particles are generally prepared by precise chemical methods such as sol-gel method. Young's modulus and Poisson's ratio are uniform, therefore their nominal values (for the particles, an average length l_{G}=1 μm, an average width w_{G}=0.4 μm, an average thickness t_{G}=0.4 μm, Young's modulus E_{G}=400 GPa and Poisson's ratio v_{G}=0.17) are used; furthermore, the above bounded probabilistic uncertainties are described by random variables subject to generalized beta distribution; the uncertainty information is summarized as shown in Table 1.

TABLE 1
Summary of the uncertainty information of the cutterhead support
structure in the tunnel boring mechanism

| Uncertainty | Type of uncertain variable | Value range | Uncertain parameter * |
|---|---|---|---|
| E_{M} (GPa) | Bounded probabilistic variable | [200.00, 210.00] | μ_{EM} = 206.00, σ_{EM} = 1.20 |
| | α_{EM} = 5.30, β_{EM} = 6.28 | | |
| v_{M} | Bounded probabilistic variable | [0.28, 0.32] | μ_{EM} = 0.30, σ_{EM} = 5.00E−3 |
| | α_{vM} = β_{vM} = 5.32 | | |
| f(kN/m) | Interval variable | [1.90E+5, 2.10E+5] | <2.00E+5, 1.00E+5> |
| α | Interval variable | [−70.00°, −110.00°] | <−90.00°, 20.00°> |

* Midpoint and radius for interval variables; mean and standard deviation for bounded probabilistic variables.

2. The design domain of the support structure is discretized, specifically:

The force condition of the cutterhead support structure in the tunnel boring mechanism is simplified into a two-dimensional plane stress state; the support structure to be optimized is placed in a regular rectangular design domain (the range outlined by the outermost solid line in FIG. 4, the size of which is X×Y=450 mm×850 mm), and the rectangular design domain is divided into Nₓ×N_{y} square units, where Nₓ, N_{y} are division numbers along the Nₓ, N_{y} axes, the values of which are Nₓ=180, N_{y}=340; and each unit is given a unique design variable ρₑ∈[0,1] (e=1, 2, . . . , 180×340).

3. The volume distribution of the SiC particle reinforcement in the high-strength low-alloy steel matrix is discretized, specifically:

3.1) The volume fraction of the particle reinforcement in the matrix of the support structure only changes along y axis; the volume fraction of the particle reinforcement in the lth (l=1,2, . . . , 340) layer is δₗ;

3.2) Young's modulus and Poisson's ratio of each element in the lth (l=1,2, . . . , 340) layer are calculated based on a Halpin-Tsai microstructure model;

3.3) By introducing a penalty factor p=3 and specifying the minimum allowable value of Young's modulus Eₘᵢₙ=(1E−3)GPa, the Young's modulus of each element in the lth (l=1,2, . . . , 340) layer under the topology optimization framework can finally be expressed as:

Eₑ^{<i>}(ρₑ)=Eₘᵢₙ+ρₑ^{p}(E₀ₑ^{<i>}−Eₘᵢₙ) (e∈l^{<e>}, l=1,2, . . . ,340) Eq. 20

4. Physical constraints and geometric constraints are imposed, specifically:

4.1) Geometric constraints: as shown in FIG. 4, there is no need to set material elements that are forcibly retained or removed in the design domain Ω.

4.2) Physical constraints: according to the framework of classical finite element method, all elements at the bottom of the support structure in FIG. 4 are set as fixed constraints, and the right side allows displacement in y direction; in FIG. 4, the upper part of the support structure is applied with a uniformly distributed linear load, which has uncertain amplitude f and direction angle α.

5. Taking the structural yield of the support structure under the influence of hybrid interval and bounded probabilistic uncertainties as an objective to be optimized, and taking the mean and standard deviation of the structural yield under the worst working condition as the representation of the objective, a collaborative robust optimization design model for structural topology and material distribution is established:

$${min}_{ρ , δ} \{ {μ}_{c ( ρ , δ , X , \tilde{I} )} , {σ}_{c ( ρ , δ , X , \tilde{I} )} \} \qquad Eq . 21$$

$$s . t . \{ \begin{matrix}\tilde{I} = arg {min}_{I} c ( ρ , δ , {μ}_{X} , I ) \\ s . t . ρ = {ρ}^{this \_ itr} , δ = {δ}^{this \_ itr}\end{matrix}$$

$${g}_{1} ( ρ ) = {V}_{1} ( ρ ) / {V}_{0} = {\sum }_{e}^{180 \times 340} {ρ}_{e} / {V}_{0} \leq 0 \text{.55}$$

$${g}_{2} ( ρ , δ ) = {V}_{2} ( ρ , δ ) / {V}_{1} ( ρ ) = {\sum }_{l}^{340} {\sum }_{e ∈ {l}^{〈 e 〉}}^{180} {ρ}_{e} \cdot {δ}_{l} / {V}_{1} ( ρ ) \leq 1.5 \%$$

$$K ( ρ , δ , X ) U = F ( I )$$

$$ρ = {( {ρ}_{1} , {ρ}_{2} , … , {ρ}_{180 \times 340} )}^{T} , 0 \leq {ρ}_{min} \leq {ρ}_{e} \leq 1 ( e = 1 , 2 , … , 180 \times 340 )$$

$$δ = {( {δ}_{1} , {δ}_{2} , … , {δ}_{340} )}^{T} , 0 \leq {δ}_{min} \leq {δ}_{l} \leq 2. \% ( l = 1 , 2 , … , 340 )$$

$$X = {( {E}_{M} , {ν}_{M} )}^{T} , I = {( f , α )}^{T}$$

$$where ρ = {( {ρ}_{1} , {ρ}_{2} , … , {ρ}_{190 \times 340} )}^{T} and δ = {( {δ}_{1} , {δ}_{2} , … , {δ}_{340} )}^{T}$$

are the design vectors for topology and material distribution respectively, and the minimum allowable value of the design variables is ρₘᵢₙ=0.001, δₘᵢₙ=0%, and X=(E_{M}, v_{M})^{T} is a bounded probabilistic uncertainty vector; I=(f, α)^{T} is an interval uncertain vector;

$${V}_{1} ( ρ ) = {\sum }_{e}^{180 \times 340} {ρ}_{e}$$

is the volume of the current structure; V̅=0.55 is the space utilization rate of the design domain;

$${V}_{2} ( ρ , δ ) = {\sum }_{I}^{340} {\sum }_{e ∈ {l}^{〈 e 〉}}^{180} {ρ}_{e}^{p} \cdot {δ}_{l}$$

is the current usage of the particle reinforcement; and V̅_{GPL}=1.5% is the volume proportion of the structure occupied by the reinforcement;

K(ρ,δ, X)U=F(I) is an equilibrium equation, where K(ρ,δ,X) is a 2(181×341)×2(181×341)-dimensional global stiffness matrix influenced by the bounded probabilistic uncertainty vector X and two sets of design vectors ρ, δ, and K(ρ,δ,X) is denoted as K for the concise sake; F(I) is a 2(181×341)-dimension nodal force vector; U is a 2(181×341)-dimensional nodal displacement vector; c(ρ,δ,X,Ĩ) is the structural yield of the support structure under the worst working condition Ĩ; μ_{c(ρ,δ,X,Ĩ)}, σ_{c(ρ,δ,X, Ĩ)} are the mean and standard deviation of the structural yield c(ρ,δ,X ,Ĩ) under the worst working condition and the influence of bounded probabilistic uncertainty vector X.

The worst working condition of the cutterhead support structure in the tunnel boring mechanism is determined by the following steps:

5.1) According to the classical finite element method, the structural yield considering both interval and bounded probabilistic uncertainties is written as:

c(ρ, δ,X, I)=U^{T}K(ρ, δ, X)U=F(I)^{T}K⁻¹(ρ, δ, X)F(I) Eq. 22

5.2) The mean vector μₓ=(μ_{E}_{_{M}}, μᵥ_{_{M}})^{T} is defined, where μ_{E}_{_{M}}, μᵥ_{_{M}} are the mean of uncertainties E_{M}, v_{M}; let X=μ_{X} in the structural yield c(ρ,δ,X,I), then the structural yield only contains an interval uncertainty I and can be written as c(ρ,δ,μ_{X},I)=c(ρ,δ,I).

5.3) The nodal force vector is written as the sum of the nodal force vectors of all external loads. In this example, there is only one uncertain external load, then:

F(I)=F(f,α) Eq. 23

And there is:

$$F = {F}_{x} + {F}_{y} = ‖ {F}_{x} ‖ \frac{{F}_{x}}{‖ {F}_{x} ‖} + ‖ {F}_{y} ‖ \frac{{F}_{y}}{‖ {F}_{y} ‖} = {f}_{x} {e}_{x} + {f}_{y} {e}_{y} \qquad Eq . 24$$

5.4) According to the linear elastic hypothesis, the overall effect of multiple uncertain loads can be equivalent to the superposition of the individual effect of each load, then:

c(ρ,δ,I)=(F(f,α))^{T}K⁻¹F(f,α) Eq. 25

The amplitude and direction angle of the uncertain load in the above equation are derived, and the worst working condition Î=(\hat{f}, \hat{α})^{T} is solved by a gradient descent method based on the obtained derivative information; under the influence of the bounded probabilistic uncertainty vector X, the mean and standard deviation of the structural yield c(ρ,δ,X,Ĩ) under the worst working condition are calculated as follows:

5.5) μₓ in c(ρ, δ,μ_{X}, Ĩ) is restored as the bounded probabilistic uncertainty vector X, and c(ρ,δ, X,Ĩ) is denoted as \tilde{c}(ρ,δ,X).

5.6) By a Rahman univariate dimension-reduction method, \tilde{c}(ρ,δ,X) is expanded:

$$\tilde{c} ( ρ , δ , X ) \approx {\sum }_{i = 1}^{2} \tilde{c} ( ρ , δ , {X}_{〈 i 〉} ) - \tilde{c} ( ρ , δ , {μ}_{X} ) \qquad Eq . 26$$

$$where {X}_{〈 i 〉} ( i = 1 , 2 )$$

is as follows

X_{<1>}=(E_{M}, μᵥ_{_{M}})^{T}X_{<2>}=(μ_{E}_{_{M}}, v_{M})^{T} Eq. 27

5.7) According to the expansion equation in 5.6), the high-dimensional integrals of the first-order and second-order origin moments of \tilde{c}(ρ,δ,X) are transformed into several one-dimensional integrals:

$$E ( \tilde{c} ( ρ , δ , X ) ) \approx E [ {\sum }_{i = 1}^{2} \tilde{c} ( ρ , δ , {X}_{〈 i 〉} ) - \tilde{c} ( ρ , δ , {μ}_{X} ) ] = {\sum }_{i = 1}^{2} {\int }_{0}^{+ ∞} \tilde{c} ( ρ , δ , {X}_{〈 i 〉} ) \cdot ψ ( {X}_{i} ) d {X}_{i} - \tilde{c} ( ρ , δ , {μ}_{X} ) \qquad Eq . 28$$

$$E ( {\tilde{c}}^{2} ( ρ , δ , X ) ) \approx E [ {( {\sum }_{i = 1}^{2} \tilde{c} ( ρ , δ , {X}_{〈 i 〉} ) - \tilde{c} ( ρ , δ , {μ}_{X} ) )}^{2} ] = {\sum }_{i = 1}^{2} {\int }_{0}^{+ ∞} {\tilde{c}}^{2} ( ρ , δ , {X}_{〈 i 〉} ) \cdot ψ ( {X}_{i} ) {dX}_{i} + 2 {\sum }_{1 \leq p < q \leq 2} [ {\int }_{0}^{+ ∞} \tilde{c} ( ρ , δ , {X}_{〈 p 〉} ) \cdot ψ ( {X}_{p} ) d {X}_{p} ] \cdot [ {\int }_{0}^{+ ∞} \tilde{c} ( ρ , δ , {X}_{〈 q 〉} ) \cdot ψ ( {X}_{q} ) d {X}_{q} ] - 2 \tilde{c} ( ρ , δ , {μ}_{X} ) {\sum }_{i = 1}^{2} {\int }_{0}^{+ ∞} \tilde{c} ( ρ , δ , {X}_{〈 i 〉} ) \cdot ψ ( {X}_{i} ) {dX}_{i} + {\tilde{c}}^{2} ( ρ , δ , {μ}_{X} ) \qquad Eq . 29$$

5.8) Each one-dimensional integral in the above equation is calculated by a Laguerre integration format:

$${\int }_{0}^{+ ∞} \tilde{c} ( ρ , δ , {X}_{〈 i 〉} ) \cdot ψ ( {X}_{i} ) {dX}_{i} \approx {\sum }_{j = 1}^{t} \tilde{c} ( ρ , δ , {X}_{〈 i 〉}^{( j )} ) exp ( {X}_{i}^{( j )} ) {λ}^{( j )} \qquad Eq . 30$$

where the number of Laguerre integration points t=6, Xᵢ^{(j)}, λ^{(j)}, (j=1,2, . . . , 6) are respectively the integration points and their corresponding weights given by Laguerre integration rules; X_{<i>}^{(j)} is determined by Eq. 27 using Xᵢ^{(j)};

5.9) The mean and standard deviation of the structural yield under the worst working condition can be obtained by the following equation:

$$\{ \begin{matrix}{μ}_{c ( ρ , δ , X , \tilde{I} )} = E ( \tilde{c} ( ρ , δ , X ) ) \\ {σ}_{c ( ρ , δ , X , \tilde{I} )} = \sqrt{E ( {\tilde{c}}^{2} ( ρ , δ , X ) ) - {E}^{2} ( \tilde{c} ( ρ , δ , X ) )}\end{matrix} \qquad Eq . 31$$

6. The collaborative robust optimization design model for the cutterhead support structure in the tunnel boring mechanism is iteratively solved by a moving asymptote algorithm.

6.1) Taking the first iteration as an example, the solution process of the collaborative robust optimization design model for the cutterhead support structure in the tunnel boring mechanism is as follows: weighted objective function:

J(ρ, δ, X, I)=μ_{c(ρ, δ,X,Ĩ)}+0.5σ_{c(ρ,δ,X,Ĩ)} Eq. 32

6.2) The gradient of objective and constraint functions with respect to ρₑ:

$$\frac{J ( ρ , δ , X , I )}{\partial {ρ}_{e}} = \frac{\partial {μ}_{c ( ρ , δ , X , \tilde{I} )}}{\partial {ρ}_{e}} + 0.5 \frac{\partial {σ}_{c ( ρ , δ , X , \tilde{I} )}}{\partial {ρ}_{e}} \qquad Eq . 33$$

$$\frac{\partial {g}_{1} ( ρ )}{\partial {ρ}_{e}} = \frac{1}{{V}_{0}} \frac{\partial {g}_{2} ( ρ )}{\partial {ρ}_{e}} = \frac{{δ}_{l} \cdot {V}_{1} ( ρ ) - {\sum }_{l}^{340} {\sum }_{e ∈ {l}^{〈 e 〉}}^{180} {ρ}_{e} \cdot {δ}_{l}}{{( {V}_{1} ( ρ ) )}^{2}} ( e ∈ {l}^{〈 e 〉} ) \qquad Eq . 34$$

$$6.2 \text{.1} ) Eq . 28 , Eq . 29 and Eq . 31 are substituted i nto Eq . 33 to obtain :$$

$$\frac{J ( ρ , δ , X , I )}{\partial {ρ}_{e}} = \frac{\partial {μ}_{c ( ρ , δ , X , \tilde{I} )}}{\partial {ρ}_{e}} + 0.5 \frac{\partial {σ}_{c ( ρ , δ , X , \tilde{I} )}}{\partial {ρ}_{e}} = \frac{\partial E ( \tilde{c} ( ρ , δ , X ) )}{\partial {ρ}_{e}} + \frac{0.5}{2 {σ}_{c ( ρ , δ , X , \tilde{I} )}} \cdot {[ \frac{\partial E ( {\tilde{c}}^{2} ( ρ , δ , X ) )}{\partial {ρ}_{e}} - 2 E ( \tilde{c} ( ρ , δ , X ) ) \cdot \frac{\partial E ( \tilde{c} ( ρ , δ , X ) )}{\partial {ρ}_{e}} ]}^{- 1 / 2} \qquad Eq . 35$$

The gradient terms

$$\frac{\partial E ( \tilde{c} ( ρ , δ , X ) )}{\partial {ρ}_{e}} , \frac{\partial E ( {\tilde{c}}^{2} ( ρ , δ , X ) )}{\partial {ρ}_{e}}$$

in Eq. 35 can be obtained from the derivation with respect to ρₑ in Eq.28 and Eq.29, respectively;

6.2.2) The gradient term

$$\frac{\partial \tilde{c} ( ρ , δ , X ° )}{\partial {ρ}_{e}}$$

included in the derivative process of 6.2.1) above are given by the classical topology optimization framework:

$$\frac{\partial \tilde{c} ( ρ , δ , X ° )}{\partial {ρ}_{e}} = - p {{ρ}_{e}^{p - 1} ( {u}_{e}^{∘} )}^{T} {k}_{e}^{∘} {u}_{e}^{∘} \qquad Eq . 36$$

where X^{∘} is the abbreviation of X_{<i>}^{(j)}, X_{<p>}^{(j)}, X_{<q>}^{(j)}, and μ_{X}, which are all certain realization of the bounded probabilistic uncertainty vector; kₑ^{∘} is the element stiffness matrix of the element e in this realization; uₑ^{∘} is the element displacement matrix of the element e under this realization, which is extracted from the nodal displacement vector;

6.2.3) The gradient terms

$$\frac{\partial E ( \tilde{c} ( ρ , δ , X ) )}{\partial {ρ}_{e}} , \frac{\partial E ( {\tilde{c}}^{2} ( ρ , δ , X ) )}{\partial {ρ}_{e}}$$

are substituted into Eq.35 to obtain the gradient result:

$$\frac{J ( ρ , δ , X , I )}{\partial {ρ}_{1}} = - 0.01 , \qquad Eq . 37$$

$$\frac{J ( ρ , δ , X , I )}{\partial {ρ}_{2}} = - 0.00 , … ,$$

$$\frac{J ( ρ , δ , X , I )}{\partial {ρ}_{180 \times 340}} = - 388.24 , …$$

6.3) The gradient of the objective and constraint functions with respect to δₗ:

$$\frac{J ( ρ , δ , X , I )}{\partial {δ}_{l}} = \frac{\partial {μ}_{c ( ρ , δ , X , \tilde{I} )}}{\partial {δ}_{l}} + 0.5 \frac{\partial {σ}_{c ( ρ , δ , X , \tilde{I} )}}{\partial {δ}_{l}} \qquad Eq . 38$$

$$\frac{\partial {g}_{1} ( ρ )}{\partial {δ}_{l}} = 0 \frac{\partial {g}_{2} ( ρ , δ )}{\partial {δ}_{l}} = {\sum }_{e ∈ {l}^{〈 e 〉}}^{180} {ρ}_{e} / {V}_{1} ( ρ ) \qquad Eq . 39$$

$$6.3 \text{.1} ) Eq . 28 , Eq . 29 are substituted into Eq . 38 to obtain :$$

$$\frac{J ( ρ , δ , X , I )}{\partial {δ}_{l}} = \frac{\partial {μ}_{c ( ρ , δ , X , \tilde{I} )}}{\partial {δ}_{l}} + 0.5 \frac{\partial {σ}_{c ( ρ , δ , X , \tilde{I} )}}{\partial {δ}_{l}} = \frac{\partial E ( \tilde{c} ( ρ , δ , X ) )}{\partial {δ}_{l}} + \frac{0.5}{2 {σ}_{c ( ρ , δ , X , \tilde{I} )}} \cdot {[ \frac{\partial E ( {\tilde{c}}^{2} ( ρ , δ , X ) )}{\partial {δ}_{l}} - 2 E ( \tilde{c} ( ρ , δ , X ) ) \cdot \frac{\partial E ( \tilde{c} ( ρ , δ , X ) )}{\partial {δ}_{l}} ]}^{- 1 / 2} \qquad Eq . 40$$

The gradient terms

$$\frac{\partial E ( \tilde{c} ( ρ , δ , X ) )}{\partial {δ}_{l}} , \frac{\partial E ( {\tilde{c}}^{2} ( ρ , δ , X ) )}{\partial {δ}_{l}}$$

in Eq. 40 can be obtained from derivation with respect to δₗ in Eq. 28 and Eq. 29, respectively;

6.3.2) The gradient term

$$\frac{\partial \tilde{c} ( ρ , δ , {X}^{∘} )}{\partial {δ}_{l}}$$

included in the derivation of the above 6.3.1) is given by the classical SIMP topology optimization framework:

$$\frac{\partial \tilde{c} ( ρ , δ , {X}^{∘} )}{\partial {δ}_{l}} = - {{ρ}_{e}^{p} ( {u}_{e}^{∘} )}^{T} \frac{\partial {k}_{e}^{∘}}{\partial {δ}_{l}} {u}_{e}^{∘} \qquad Eq . 41$$

where X^{∘} is the abbreviation of X_{<i>}^{(j)}, X<p>^{(j)}, X_{<q>}^{(j)} and μ_{X}, which are all certain realization of the bounded probabilistic uncertainty vector; uₑ^{∘} is the element displacement matrix of the element e under this realization, which is extracted from the nodal displacement vector; kₑ^{∘} is the element stiffness matrix of the element e under this realization, which is a function of the volume fraction of particle reinforcement, specifically:

$${k}_{e}^{∘} = {k}_{e}^{∘} ( {δ}_{l} ) = \frac{{E}_{e}^{〈 l 〉}}{1 - {( {ν}_{e}^{〈 l 〉} )}^{2}} \cdot [ \begin{matrix}k ( 1 ) & k ( 2 ) & k ( 3 ) & k ( 4 ) & k ( 5 ) & k ( 6 ) & k ( 7 ) & k ( 8 ) \\ & k ( 1 ) & k ( 8 ) & k ( 7 ) & k ( 6 ) & k ( 5 ) & k ( 4 ) & k ( 3 ) \\ & & k ( 1 ) & k ( 6 ) & k ( 7 ) & k ( 4 ) & k ( 5 ) & k ( 2 ) \\ & & & k ( 1 ) & k ( 8 ) & k ( 3 ) & k ( 2 ) & k ( 5 ) \\ & & & & k ( 1 ) & k ( 2 ) & k ( 3 ) & k ( 4 ) \\ & & & & & k ( 1 ) & k ( 8 ) & k ( 7 ) \\ & symmetric & & & & & k ( 1 ) & k ( 6 ) \\ & & & & & & & k ( 1 )\end{matrix} ] \qquad Eq . 42$$

where Eₑ^{<l> and v}ₑ^{<l>} are the material properties of the element e (e∈l^{<e>}, l=1,2, . . . , 340) in the lth layer, k(i)(i=1,2, . . . , 8) is the ith element of the vector k; the vector k is defined as follows:

$$k = [ \begin{matrix}\begin{matrix}\begin{matrix}\begin{matrix}\begin{matrix}\begin{matrix}\begin{matrix}\frac{1}{2} - \frac{{ν}_{e}^{〈 l 〉}}{6} & \frac{1}{8} + \frac{( {ν}_{e}^{〈 l 〉} )}{8}\end{matrix} & - \frac{1}{4} - \frac{{ν}_{e}^{〈 l 〉}}{12}\end{matrix} & - \frac{1}{8} + \frac{3 {ν}_{e}^{〈 l 〉}}{8}\end{matrix} & - \frac{1}{4} + \frac{{ν}_{e}^{〈 l 〉}}{12}\end{matrix} & - \frac{1}{8} - \frac{{ν}_{e}^{〈 l 〉}}{8}\end{matrix} & \frac{{ν}_{e}^{〈 l 〉}}{6}\end{matrix} & \frac{1}{8} - \frac{3 {ν}_{e}^{〈 l 〉}}{8}\end{matrix} ] \qquad Eq . 43$$

6.3.3) The square matrix in Eq.42 is recorded as D, then the gradient of the element stiffness matrix kₑ^{∘} with respect to δₗ is:

$$\frac{\partial {k}_{e}}{\partial {δ}_{l}} = \frac{\begin{matrix}\frac{\partial {E}_{e}^{〈 l 〉}}{\partial {δ}_{l}} \cdot ( 1 - {( {ν}_{e}^{〈 l 〉} )}^{2} ) + \\ 2 {E}_{e}^{〈 l 〉} \cdot {ν}_{e}^{〈 l 〉} \frac{\partial {ν}_{e}^{〈 l 〉}}{\partial {δ}_{l}}\end{matrix}}{( 1 - {( {ν}_{e}^{〈 l 〉} )}^{2} )} \cdot D + \frac{{E}_{e}^{〈 l 〉}}{1 - {( {ν}_{e}^{〈 l 〉} )}^{2}} \cdot \frac{\partial D}{\partial {δ}_{l}} \qquad Eq . 44$$

6.3.4) All the calculation results are substituted into Eq.40 to obtain the final gradient results of the objective function with respect to δₗ, which are as follows:

$$\frac{J ( ρ , δ , X , I )}{\partial {δ}_{1}} = 3.04 , \qquad Eq . 45$$

$$\frac{J ( ρ , δ , X , I )}{\partial {δ}_{2}} = 3.04 , … ,$$

$$\frac{J ( ρ , δ , X , I )}{\partial {δ}_{339}} = - 2.39 ,$$

$$\frac{J ( ρ , δ , X , I )}{\partial {δ}_{340}} = - 2.52$$

6.4) According to the above obtained gradient information of the objective and constraint functions with respect to the two sets of design variables, a moving asymptote algorithm is used to update two sets of design variables at the same time, and the design variables after the first iteration are as follows:

ρ₁=0.98, ρ₂=0.98, . . . , ρ₂₀₀=0.632, ρ₂₀₁=0.607, Eq. 46

δ₁=0.017, δ₁=0.017, . . . , δ₂₀₀=0.014, δ₂₀₁=0.014, Eq. 47

6.5) The difference between the objective function values in the current and previous iterations is checked. Since it is the first iteration, the difference is defined as the current objective function value, which does not meet the convergence threshold of 0.01, therefore steps 6.1) to 6.5) are repeated.

The interception part of the optimal solution finally obtained is as follows:

ρ₁=1.00, ρ₂=1.00, . . . , ρ_{90×170-1}=1E−3, ρ_{90×170}=1E−3, . . . ρ_{180×340}=1.00 Eq. 48

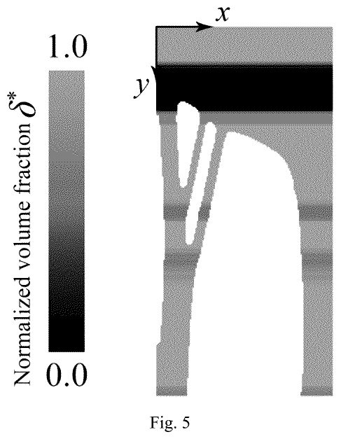

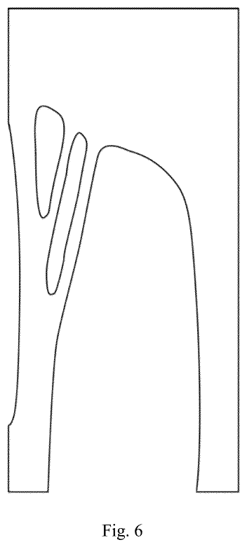

Iterative optimization converges at the 104th generation, and the topological structure corresponding to the optimal solution is shown in FIG. 5; the objective performance of the optimal solution is μ_{c(ρ, δ,X,Ĩ)}=9.9544E+5, σ_{c(ρ, δ,X,Ĩ)}=1.0528E+3, and the worst working condition corresponding to the optimal solution is Ĩ=(2.10E+5,−94.33^{∘})^{T}: this value can be used for further engineering analysis to meet the robust design target and working requirements of the cutterhead support structure in the tunnel boring mechanism; the changing pattern of the SiC particle reinforcement in the height direction of the support structure after collaborative optimization is shown in the gray form in FIG. 5, in which the vertical coordinate is the normalized volume fraction δ*:

$${δ}^{*} = \frac{δ - {δ}_{min}}{{δ}_{max} - {δ}_{min}} ∈ [ 0 , 1 ] \qquad Eq . 49$$

It can be seen from FIG. 5 that more particle reinforcement is required at the top of the support structure, and this optimization result accords with engineering experience; combined with the optimized performance of the structural yield, the effectiveness of the proposed method is verified; after further smoothing the contour of the topology and material collaborative robust optimization result, the final design of the cutterhead support structure in the tunnel boring mechanism is shown in FIG. 6.

It should be declared that the contents and specific embodiments of the present disclosure are intended to prove the practical application of the technical solution provided by the present disclosure, and shall not be construed as limiting the protection scope of the present disclosure. Any modification and change made to the present disclosure within the spirit of the present disclosure and the scope of protection of the claims fall within the scope of protection of the present disclosure.

What is claimed is:

1. A topology and material collaborative robust optimization design method for a composite material support structure, comprising:
step 1), considering following uncertainties in manufacture and service process of a particle reinforced composite support structure, comprising:
material properties of a matrix material and a particle reinforcement of the support structure, and
an amplitude and a direction of an external load on the support structure;
wherein the amplitude and direction of the external load with difficulty to obtain sufficient sample information are regarded as interval uncertainties, material properties of the matrix material and the particle reinforcement with sufficient sample information are regarded as bounded probabilistic uncertainties, and every bounded probabilistic uncertainty is described as a random variable subject to generalized beta distribution;
step 2), discretizing a design domain of the support structure, comprising:
simplifying a force condition of the support structure into a two-dimensional plane stress state, retaining installation holes and removing structural details, placing the simplified support structure in a regular rectangular design domain, and dividing the design domain into Nₓ×N_{y} square units, where Nₓ, N_{y} are numbers of divisions along x, y axes, respectively, and imparting each unit with a unique design variable ρₑ∈[0,1] (e=1,2, . . . , Nₓ·N_{y}) based on a solid isotropic material with penalization (SIMP) topology optimization framework;
step 3), discretizing a volume distribution of the particle reinforcement in the matrix of the support structure, comprising:
step 3.1), assuming that the volume fraction of the particle reinforcement in the matrix of the support structure only changes along the y axial, the volume fraction with the same y coordinate is regarded as a constant, and the volume fraction of the particle reinforcement in each layer is denoted as δₗ (l=1,2, . . . , N_{y});
step 3.2), calculating the Young's modulus E₀ₑ^{<l>} and the Poisson's ratio vₑ^{<l>} of every unit in an lth layer based on a Halpin-Tsai microstructure model; and
step 3.3), introducing a penalty factor p to calculate the Young's modulus Eₑ^{<l>} of every unit in the lth layer under the topology optimization framework as follows:
Eₑ^{<l>}(ρₑ)=Eₘᵢₙ+ρₑ^{p}(E₀ₑ^{<l>}−Eₘᵢₙ) (e∈l^{<e>}, l=1,2, . . . , N_{y}) Eq. 1
where Eₘᵢₙ is a minimum allowable value, and l^{21 e>} is a set of unit serial numbers contained in the lth layer;
step 4) imposing physical and geometric constraints on the discretized support structure, comprising:
step 4.1) imposing physical constraints comprising fixing or support and an external load according to the classical finite element method;
step 4.2) imposing geometric constraints comprising specified holes in the support structure and areas where materials are forcibly retained by setting a design variable corresponding to an element in the hole as ρₑ≡0 and setting a design variable corresponding to an element in the area where materials are to be retained as ρₑ≡1, and keeping the values thereof unchanged in subsequent optimization process;
step 5) establishing a topology and material distribution collaborative robust optimization design model of a particle reinforced composite material support structure, by taking a structural yield c of the support structure under influences of bounded hybrid uncertainties as an objective performance to be optimized, and characterizing the objective performance by a mean and a standard deviation of the structural yield under the worst working condition, wherein the model is shown in Eq.2:
$${min}_{ρ , δ} \{ {μ}_{c ( ρ , δ , X , \tilde{I} )} , {σ}_{c ( ρ , δ , X , \tilde{I} )} \} \qquad Eq . 2$$
$$s . t . \{ \begin{matrix}\tilde{I} = arg {min}_{I} c ( ρ , δ , {μ}_{X} , I ) \\ s . t . ρ = {ρ}^{this \_ itr} , δ = {δ}^{this \_ itr}\end{matrix}$$
$${g}_{1} ( ρ ) = {V}_{1} ( ρ ) / {V}_{0} = {\sum }_{e}^{{N}_{x} {N}_{y}} {ρ}_{e} / {V}_{0} \leq \overline{V}$$
$${g}_{2} ( ρ , δ ) = {V}_{2} ( ρ , δ ) / {V}_{1} ( ρ ) = {\sum }_{l}^{{N}_{y}} {\sum }_{e ∈ {l}^{〈 e 〉}}^{{N}_{x}} {ρ}_{e} \cdot {δ}_{l} / {V}_{1} ( ρ ) \leq {\overline{V}}_{G P L}$$
$$K ( ρ , δ , X ) U = F ( I )$$
$$ρ = {( {ρ}_{1} , {ρ}_{2} , … , {ρ}_{{N}_{x} \cdot {N}_{y}} )}^{T} , 0 \leq {ρ}_{min} \leq {ρ}_{e} \leq 1 ( e = 1 , 2 , … , {N}_{x} \cdot {N}_{y} )$$
$$δ = {( {δ}_{1} , {δ}_{2} , … , {δ}_{{N}_{y}} )}^{T} , 0 \leq {δ}_{min} \leq {δ}_{l} \leq {δ}_{max} ( l = 1 , 2 , … , {N}_{y} )$$
$$X = {( {X}_{1} , {X}_{2} , … , {X}_{m} )}^{T} , I = {( {f}_{1} , {f}_{2} , … , {f}_{n} , {α}_{1} , {α}_{2} , {α}_{n} )}^{T}$$
where 92 =(ρ₁, ρ₂, . . . , ρ_{N}_{ₓ}_{·N}_{_{y}})^{T} and δ=(δ₁, δ₂, . . . , δ_{N}_{_{y}})^{T} are the design vectors for topology optimization and material distribution respectively, ρₘᵢₙ is a minimum allowable value of a topology optimization design variable, δₘᵢₙ and δₘₐₓ are minimum and maximum allowable values of a material distribution design variable, respectively, the bounded probabilistic uncertainty vector X=(X₁, X₂, . . . , Xₘ)^{T} comprises m uncertain material properties of the matrix and reinforcement of the support structure; the interval uncertainty vector I=(f₁, f₂, . . . , fₙ, α₁, α₂, . . . , αₙ)^{T} comprises amplitudes f₁, f₂, . . . fₙ and direction angles α₁, α₂, . . . , αₙ of n uncertain external loads on the support structure, and two sets of design vectors in current iteration are ρ=ρ^{this_itr}, δ=δ^{this_itr}, respectively.
where g₁(ρ) is a constraint function about a structural topology,
$${V}_{1} ( ρ ) = {\sum }_{e}^{{N}_{x} {N}_{y}} {ρ}_{e}$$
is a total volume of a current support structure, V₀ is a volume of the design domain, V̅ is a given spatial utilization ratio of the design domain, and ρₑ=V̅ is initialized;
where g₂(ρ, δ) is a constraint function about the usage of the reinforcement,
$${V}_{2} ( ρ , δ ) = {\sum }_{l}^{{N}_{y}} {\sum }_{e ∈ {l}^{〈 e 〉}}^{{N}_{x}} {ρ}_{e} \cdot {δ}_{l}$$
is the usage of the particle reinforcement in the current support structure, V̅_{GPL} is a given utilization rate of the particle reinforcement, and δₗ=V̅_{GPL} is initialized;
where in a balance equation K(ρ,δ,X)U=F(I) of a support structure, U is a (2(Nₓ+1)(N_{y}+1))-dimensional nodal displacement vector; K(ρ,δ,X) is a (2(Nₓ+1)(N_{y}+1))×(2(Nₓ+1)(N_{y}+1))-dimensional global stiffness matrix; F(I) is a (2(Nₓ+1)(N_{y}+1))-dimensional nodal force vector.
where Ĩ is an interval uncertainty vector corresponding to the worst working condition of the support structure; c(ρ, δ,X ,Ĩ) is a yield of the support structure under the worst working condition Ĩ, and wherein a specific way to determine the worst working condition Ĩ is as follows:
step 5.1) denoting a structural yield under the influences of both interval and bounded probabilistic uncertainties as Eq.3:
c(ρ, δ,X,I)=U^{T}K(ρ,δ,X)U=F(I)^{T}K⁻¹(ρ, δ,X)F(I) Eq. 3
step 5.2) setting X=μ_{X}=(μ_{X}_{₁}, μ_{X}_{₂}, . . . , μₓ_{ₘ})^{T} in c(ρ,δ,X,I), where μ_{X}_{₁}, μ_{X}_{₂}, . . . , μ_{X}_{ₘ} are the averages of uncertainties X₁, X₂, . . . , Xₘ, respectively, the structural yield is only influenced by interval uncertainties I, which is written as c(ρ, δ, μ_{X},I)=c(ρ,δ,I); where global stiffness matrix K is constant in each iteration;
5.3) obtaining a nodal force vector as the sum of the nodal force vectors of all external loads:
$$F ( I ) = {\sum }_{i}^{n} {F}_{i} ( {f}_{i} , {α}_{i} ) \qquad Eq . 4$$
$${F}_{i} = {F}_{ix} + {F}_{iy} = ‖ {F}_{ix} ‖ \frac{{F}_{ix}}{‖ {F}_{ix} ‖} + ‖ {F}_{iy} ‖ \frac{{F}_{iy}}{‖ {F}_{iy} ‖} = {f}_{i} cos {α}_{i} {e}_{ix} + {f}_{i} sin {α}_{i} {e}_{iy} ( i = 1 , 2 , … , n ) \qquad Eq . 5$$
where eᵢₓ, e_{iy} are unit nodal force vectors along x, y axes respectively at a node where an external load Fᵢ is imposed;
step 5.4), an overall effect of n uncertain loads is equivalent to superposition of individual effect of each load according to a theory of linear elasticity:
$$c ( ρ , δ , I ) = {[ {\sum }_{i}^{n} {F}_{i} , ( {f}_{i} , {α}_{i} ) ]}^{T} {K}^{- 1} [ {\sum }_{i}^{n} {F}_{i} , ( {f}_{i} , {α}_{i} ) ] = {\sum }_{i}^{n} {F}_{i}^{T - 1} {F}_{i} \qquad Eq . 6$$
where in Eq.6, an amplitude and a direction angle of an uncertain load are derived, respectively, and the worst working condition Ĩ=(\tilde{f}₁, \tilde{f}₂, . . . , \tilde{f}ₙ, \tilde{α}₁, \tilde{α}₂, . . . , \tilde{α}ₙ)^{T} is obtained by solving ∂c(ρ,δ, I)/∂fᵢ=0, ∂c(ρ, δ,I)/∂αᵢ=0.
where Eq.2 μ_{c(ρ, δ,X,Ĩ)}, σ_{c(ρ,δ,X,Ĩ)} are respectively the mean and standard deviation of the structural yield c(ρ, δ, X ,Ĩ) under the influence of bounded probabilistic uncertainty vector X and the worst working condition, and wherein μ_{c(ρ,δ,X,Ĩ)}, σ_{c(ρ,δ,X, Ĩ)} are calculated as follows:
step 5.5) restoring μ_{X} in c(ρ,δ,μ_{X},Ĩ) as X, and recording c(ρ,δ,X,Ĩ) is denoted as \tilde{c}(ρ, δ, X) for short;
step 5.6) expanding \tilde{c}(ρ, δ,X) using a Rahman univariate dimension-reduction method:
$$\tilde{c} ( ρ , δ , X ) \approx {\sum }_{l = 1}^{m} \tilde{c} ( ρ , δ , {X}_{< i >} ) - ( m - 1 ) \tilde{c} ( ρ , δ , {μ}_{X} ) where \qquad Eq . 7$$
$${X}_{< i >} ( i = 1 , 2 , … , m )$$
is defined as Eq.8:
X_{<i>}=(μ_{X}_{₁}, μ_{X}_{₂}, . . . , μ_{X}_{_{i−1}}, Xᵢ, μ_{X}_{ᵢ₊₁}, . . . μ_{X}_{ₘ})^{T} Eq. 8
step 5.7) According to Eq.7, transforming a high-dimensional integration of first-order and second-order origin moments of \tilde{c}(ρ,δ, X) into several one-dimensional integration operations:
$$E ( \tilde{c} ( ρ , δ , X ) ) \approx E [ {\sum }_{i = 1}^{m} \tilde{c} ( ρ , δ , {X}_{< i >} ) - ( m - 1 ) \tilde{c} ( ρ , δ , {μ}_{X} ) ] = {\sum }_{i = 1}^{m} {\int }_{0}^{+ ∞} \tilde{c} ( ρ , δ , {X}_{< i >} ) \cdot ψ ( {X}_{i} ) d {X}_{i} - ( m - 1 ) \tilde{c} ( ρ , δ , {μ}_{X} ) \qquad Eq . 9$$
$$E ( {\tilde{c}}^{2} ( ρ , δ , X ) ) \approx E [ {( {\sum }_{i = 1}^{m} \tilde{c} ( ρ , δ , {X}_{< i >} ) - ( m - 1 ) \tilde{c} ( ρ , δ , {μ}_{X} ) )}^{2} ] = {\sum }_{j = 1}^{m} {\int }_{0}^{+ ∞} {\tilde{c}}^{2} ( ρ , δ , {X}_{< i >} ) \cdot ψ ( {X}_{i} ) {dX}_{i} + 2 {\sum }_{1 \leq p < q \leq m} [ {\int }_{0}^{+ ∞} \tilde{c} ( ρ , δ , {X}_{< p >} ) \cdot ψ ( {X}_{p} ) {dX}_{p} ] \cdot [ {\int }_{0}^{+ ∞} \tilde{c} ( ρ , δ , {X}_{< q >} ) \cdot ψ ( {X}_{q} ) {dX}_{q} ] - 2 ( m - 1 ) \tilde{c} ( ρ , δ , {μ}_{X} ) {\sum }_{i = 1}^{m} {\int }_{0}^{+ ∞} \tilde{c} ( ρ , δ , {X}_{< i >} ) \cdot ψ ( {X}_{i} ) {dX}_{i} + {( m - 1 )}^{2} {\tilde{c}}^{2} ( ρ , δ , {μ}_{X} ) \qquad Eq . 10$$
where ψ(Xᵢ) in Eq.10 is a probability distribution function of bounded probabilistic uncertainty Xᵢ, which is determined when modelling Xᵢ using the generalized beta distribution;
step 5.8), calculating each one-dimensional integral in Eq.9 and Eq.10 in a Laguerre integration format:
$${\int }_{0}^{+ ∞} {\tilde{c}}^{2} ( ρ , δ , {X}_{< i >} ) \cdot ψ ( {X}_{i} ) dX \approx {\sum }_{j = 1}^{t} {\tilde{c}}^{2} ( ρ , δ , {X}_{< i >}^{( j )} ) exp ( {X}_{i}^{( j )} ) {λ}^{( j )} \qquad Eq . 11$$
where t is a number of Laguerre integration points, Xᵢ^{(j)}, λ^{(j)} are an integration point and its corresponding weight given by Laguerre integration rules, respectively, X_{<i>}^{(j)} is determined using Xᵢ^{(f)} by Eq. 8;
step 5.9), obtaining the mean and standard deviation of the structural yield under the worst working condition by Eq.12:
$$\{ \begin{matrix}{μ}_{c ( ρ , δ , X , \tilde{I} )} = E ( \tilde{c} ( ρ , δ , X ) ) \\ {σ}_{c ( ρ , δ , X , \tilde{I} )} = \sqrt{E ( {\tilde{c}}^{2} ( ρ , δ , X ) ) - {E}^{2} ( {\tilde{c}}^{2} ( ρ , δ , X ) )}\end{matrix} ; \qquad Eq . 12$$
and
step 6), solving the collaborative robust optimization design model in Eq.2 by a moving asymptote algorithm, wherein each iteration comprises:
step 6.1), introducing a weight w and defining an objective function J(ρ, δ,X,I) according to Eq.13:
J(ρ,δ,X, I)=μ_{c(ρ, δ,X,Ĩ)}+wσ_{c(ρ, δ,X,Ĩ)} Eq. 13
step 6.2), calculating gradient of objective and constraint functions with respect to design variables ρₑ:
$$\frac{J ( ρ , δ , X , I )}{\partial {ρ}_{e}} = \frac{\partial {μ}_{c ( ρ , δ , X , \tilde{I} )}}{\partial {ρ}_{e}} + w \frac{\partial {σ}_{c ( ρ , δ , X , \tilde{I} )}}{\partial {ρ}_{e}} \qquad Eq . 14$$
$$\frac{\partial {g}_{1} ( ρ )}{\partial {ρ}_{e}} = \frac{1}{{V}_{0}} \qquad Eq . 15$$
$$\frac{\partial {g}_{2} ( ρ , δ )}{\partial {ρ}_{e}} = \frac{{δ}_{l} \cdot {V}_{1} ( ρ ) - {\sum }_{l}^{{N}_{y}} {\sum }_{e ∈ {l}^{< e >}}^{{N}_{x}} {ρ}_{e} \cdot {δ}_{l}}{{( {V}_{1} ( ρ ) )}^{2}} ( e ∈ {l}^{< e >} ) \qquad Eq . 16$$
step 6.3), calculating gradient of objective and constraint functions with respect to design variables δₗ:
$$\frac{J ( ρ , δ , X , I )}{\partial {ρ}_{l}} = \frac{\partial {μ}_{c ( ρ , δ , X , \tilde{I} )}}{\partial {ρ}_{l}} + w \frac{\partial {σ}_{c ( ρ , δ , X , \tilde{I} )}}{\partial {ρ}_{l}} \qquad Eq . 17$$
$$\frac{\partial {g}_{1} ( ρ )}{\partial {δ}_{l}} = 0 \qquad Eq . 18$$
$$\frac{\partial {g}_{2} ( ρ , δ )}{\partial {δ}_{l}} = {\sum }_{e ∈ {l}^{< e ≻}}^{{N}_{x}} {ρ}_{e} / {V}_{1} ( ρ ) \qquad Eq . 19$$
step 6.4), updating design vectors β, δ simultaneously by a moving asymptote algorithm based on gradient information of the objective and the constraint functions;
step 6.5), checking a difference between objective function values in current and previous iterations, wherein for a first iteration, the difference is defined as the objective function value,
when the difference is less than a convergence threshold, outputting updated design variables; and
otherwise, repeating the steps 5) to 6).

2. The topology and material collaborative robust optimization design method for a composite material support structure according to claim 1, wherein the step 6.2) further comprises:
step 6.2.1), substituting Eq.9, Eq.10 and Eq.12 into Eq.14:
$$\frac{J ( ρ , δ , X , I )}{\partial {ρ}_{e}} = \frac{\partial {μ}_{c ( ρ , δ , X , \tilde{I} )}}{\partial {ρ}_{e}} + w \frac{\partial {σ}_{c ( ρ , δ , X , \tilde{I} )}}{\partial {ρ}_{e}} = \frac{\partial E ( \tilde{c} ( ρ , δ , X ) )}{\partial {ρ}_{e}} + \frac{w}{2 {σ}_{c ( ρ , δ , X , \tilde{I} )}} \cdot {[ \frac{\partial E ( {\tilde{c}}^{2} ( ρ , δ , X ) )}{\partial {ρ}_{e}} - 2 E ( \tilde{c} ( ρ , δ , X ) ) \cdot \frac{\partial E ( \tilde{c} ( ρ , δ , X ) )}{\partial {ρ}_{e}} ]}^{- 1 / 2} \qquad Eq . 20$$
where gradient terms
$$\frac{\partial E ( \tilde{c} ( ρ , δ , X ) )}{\partial {ρ}_{e}} , \frac{\partial E ( {\tilde{c}}^{2} ( ρ , δ , X )}{\partial {ρ}_{e}}$$
in Eq. 20 are obtained from derivation with respect to ρₑ in Eq.9 and Eq.10, respectively;
step 6.2.2), obtaining gradient term
$$\frac{\partial \tilde{c} ( ρ , δ , {X}^{∘} )}{\partial {ρ}_{e}}$$
by a classical topology optimization framework:
$$\frac{\partial \tilde{c} ( ρ , δ , {X}^{∘} )}{\partial {ρ}_{e}} = - p {{ρ}_{e}^{p - 1} ( {u}_{e}^{∘} )}^{T} {k}_{e}^{∘} {u}_{e}^{∘} \qquad Eq . 21$$
where X^{∘} is an abbreviation of X_{<l>}^{(j)}, X_{<p>}^{(j)}, X_{<q>}^{(j)} and μ_{X}, which are all certain realization of the bounded probabilistic uncertainty vector, kₑ^{∘} is an element stiffness matrix of element e in this realization, and uₑ^{∘} is an element displacement matrix of element e under this realization, which is extracted from the nodal displacement vector; and
step 6.2.3), substituting the gradient terms
$$\frac{\partial E ( \tilde{c} ( ρ , δ , X ) )}{\partial {ρ}_{e}} , \frac{\partial E ( {\tilde{c}}^{2} ( ρ , δ , X ) )}{\partial {ρ}_{e}}$$
into Eq.20 to obtain a final gradient result of the objective function with respect to ρₑ.

3. The topology and material collaborative robust optimization design method for a composite material support structure, wherein the step 6.3) further comprises:
step 6.3.1), substituting Eq.9, Eq.10 and Eq.12 into Eq.17:
$$\frac{J ( ρ , δ , X , I )}{\partial {δ}_{l}} = \frac{\partial {μ}_{c ( ρ , δ , X , \tilde{I} )}}{\partial {δ}_{l}} + w \frac{\partial {σ}_{c ( ρ , δ , X , \tilde{I} )}}{\partial {δ}_{l}} = \frac{\partial E ( \tilde{c} ( ρ , δ , X ) )}{{δρ}_{l}} + \frac{w}{2 {σ}_{c ( ρ , δ , X , \tilde{I} )}} \cdot {[ \frac{\partial E ( {\tilde{c}}^{2} ( ρ , δ , X ) )}{\partial {δ}_{l}} - 2 E ( \tilde{c} ( ρ , δ , X ) ) \cdot \frac{\partial E ( \tilde{c} ( ρ , δ , X ) )}{\partial {δ}_{l}} ]}^{- 1 / 2} \qquad Eq . 22$$
where gradient terms
$$\frac{\partial E ( \tilde{c} ( ρ , δ , X ) )}{\partial {δ}_{l}} , \frac{\partial E ( {\tilde{c}}^{2} ( ρ , δ , X ) )}{\partial {δ}_{l}}$$
in Eq.22 are obtained from derivation with respect to δₗ in Eq.9 and Eq.10, respectively;
step 6.3.2), giving gradient term
$$\frac{\partial \tilde{c} ( ρ , δ , {X}^{∘} )}{\partial {δ}_{l}}$$
comprised in the derivation in the step 6.3.1) above by the classical SIMP topology optimization framework:
$$\frac{\partial \tilde{c} ( ρ , δ , {X}^{∘} )}{\partial {δ}_{l}} = - {{ρ}_{e}^{p} ( {u}_{e}^{∘} )}^{T} \frac{\partial {k}_{e}^{∘}}{\partial {δ}_{l}} {u}_{e}^{∘} \qquad Eq . 23$$
where X^{∘} is an abbreviation of X_{<i>}^{(j)}, X_{<p>}^{(j)}, X_{<q>}^{(j)} and μ_{X}, which are all certain realization of the bounded probabilistic uncertainty vector, uₑ^{∘} is an element displacement matrix of element e under this realization, which is extracted from the nodal displacement vector, kₑ^{∘} is an element stiffness matrix of element e under this realization, which is a function of the volume fraction of the particle reinforcement, specifically:
$${k}_{e}^{o} = {k}_{e}^{o} ( {δ}_{l} ) = \frac{{E}_{e}^{< l >}}{1 - {( {v}_{e}^{< l >} )}^{2}} [ \begin{matrix}k ( 1 ) & k ( 2 ) & k ( 3 ) & k ( 4 ) & k ( 5 ) & k ( 6 ) & k ( 7 ) & k ( 8 ) \\ & k ( 1 ) & k ( 8 ) & k ( 7 ) & k ( 6 ) & k ( 5 ) & k ( 4 ) & k ( 3 ) \\ & & k ( 1 ) & k ( 6 ) & k ( 7 ) & k ( 4 ) & k ( 5 ) & k ( 2 ) \\ & & & k ( 1 ) & k ( 8 ) & k ( 3 ) & k ( 2 ) & k ( 5 ) \\ & & & & k ( 1 ) & k ( 2 ) & k ( 3 ) & k ( 4 ) \\ & & & & & k ( 1 ) & k ( 8 ) & k ( 7 ) \\ & symmetry & & & & & k ( 1 ) & k ( 6 ) \\ & & & & & & & k ( 1 )\end{matrix} ] \qquad Eq . 24$$
where Eₑ^{<l>} and vₑ^{<l>} are material properties of element e (e∈l^{<e>}, l=1,2, . . . , N_{y}) in the lth layer, k(i)(i=1,2, . . . , 8) is the lth element of the vector k; the vector k is defined as follows:
$$k = [ \frac{1}{2} - \frac{{v}_{e}^{< l >}}{6} \frac{1}{8} + \frac{{v}_{e}^{< l >}}{8} - \frac{1}{4} - \frac{{v}_{e}^{< l >}}{12} - \frac{1}{8} + \frac{3 {v}_{e}^{< 1 >}}{8} - \frac{1}{4} + \frac{{v}_{e}^{< l >}}{12} - \frac{1}{8} - \frac{{v}_{e}^{< l >}}{8} \frac{{v}_{e}^{< l >}}{6} \frac{1}{8} - \frac{3 {v}_{e}^{< 1 >}}{8} ] \qquad Eq . 25$$
step 6.3.3), denoting a square matrix in Eq.24 as D, and calculating the gradient of the element stiffness matrix kₑ^{∘} with respect to δₗ in Eq.23 as follows:
$$\frac{\partial {k}_{e}^{∘}}{\partial {δ}_{l}} = \frac{\frac{\partial {E}_{e}^{< l >}}{\partial {δ}_{l}} \cdot ( 1 - {( {v}_{e}^{< 1 >} )}^{2} ) + 2 {E}_{e}^{< l >} \cdot {v}_{e}^{< 1 >} \frac{\partial {v}_{e}^{< 1 >}}{\partial {δ}_{l}}}{( 1 - {( {v}_{e}^{< 1 >} )}^{2} )} \cdot D + \frac{{E}_{e}^{< l >}}{1 - {( {v}_{e}^{< 1 >} )}^{2}} \frac{\partial D}{\partial {δ}_{l}} ; \qquad Eq . 26$$
and
step 6.3.4). substituting results of
$$\frac{\partial E ( \tilde{c} ( ρ , δ , X ) )}{\partial {ρ}_{l}} , \frac{\partial E ( {\tilde{c}}^{2} ( ρ , δ , X ) )}{\partial {ρ}_{l}}$$
into Eq.22 to obtain a final gradient result of the objective function with respect to δₗ.
